(19) United States
(12) Patent Application Publication
(10) Pub. No.: US 2008/0276159 A1
(43) Pub. Date: Nov. 6, 2008

(54) Creating Annotated Recordings and Transcripts of Presentations Using a Mobile Device

(75) Inventors: Chandrasekhar Narayanaswami, Wilton, CT (US); Mandayam T. Raghunath, Anandanagar (IN); Marcel-Catalin Rosu, Ossining, NY (US)

Correspondence Address: MICHAEL BUCHENHORNER, P.A., 8540 SW 83 STREET, SUITE 100, MIAMI, FL, 33143, US

(73) Assignee: International Business Machines Corporation, Armonk, NY (US)

(21) Appl. No.: 11/743,132

(22) Filed: May 1, 2007

(51) Int. Cl. G06F 3/14

(52) U.S. Cl. 715/202; 715/233

(57) ABSTRACT

A method for creating an annotated transcript of a presentation includes steps of: receiving an annotation stream recorded on a mobile device, wherein the annotation stream includes time stamped annotations corresponding to segments of the presentation; receiving a transcript of the presentation, wherein the transcript is time stamped; and then merging the annotation stream with the transcript of the presentation by matching the time stamps from both, for creating the annotated transcript of the presentation. A method for recording an annotation stream on a mobile device includes steps of: assigning a unique identifier to the annotation stream; creating the annotation stream, the annotation stream including annotations entered by a user of the mobile device, wherein each annotation is associated with at least one segment of the presentation; and storing the annotation stream.

### CROSS-REFERENCE TO RELATED APPLICATIONS

Not applicable.

### STATEMENT REGARDING FEDERALLY SPONSORED-RESEARCH OR DEVELOPMENT

The invention described herein was jointly funded by the Korean Ministry of Information and Communication and IBM. It was funded in part by a grant from the Republic of Korea, Institute of Information Technology and Assessment (IITA), and in part by Korea Ubiquitous Computing Lab (UCL). The government of the Republic of Korea may have certain rights under the invention.

### INCORPORATION BY REFERENCE OF MATERIAL SUBMITTED ON A COMPACT DISC

Not Applicable.

### FIELD OF THE INVENTION

The invention disclosed broadly relates to the field of annotation tools and more particularly relates to the field of creating annotated recordings and transcripts of audio/video presentations using a mobile device.

### BACKGROUND OF THE INVENTION

People often want transcripts or recordings of talks they attend and several organizations routinely record the audio and/or the video of the talks for the benefit of the people who missed the talk due to a time conflict. In many places the recording is done in an automated manner with cameras that are able to automatically track the speaker. Similarly, transcripts are generated by human transcription or automatically using voice recognition software. These transcripts and recordings may be available to the user at a later time. While a person who did not attend the talk may wish to view a recording of the talk from beginning to end, people who actually attended the live presentation may only want to refer back to portions of the talk that were of interest. Currently there is no easy way for people to do this. One can get a copy of the video/audio of the presentation or its transcription and search using the fast forward/rewind, Page Up/Page Down, and other controls to try and get to the point that was of interest, but this can be quite cumbersome, especially for a lengthy presentation.

People who are attending the live presentation may wish to create annotations that pertain to the presentation that they are currently attending. For instance, they might like to get quick access to parts of the recording or transcript that they either found difficult to follow during the presentation, parts that require follow-up or delegation, parts that need to be forwarded to other employees, and so forth. People who are reviewing a recorded presentation or transcript may also want to further annotate the recorded presentation or transcript with their personal annotations. Currently there is no known method for doing this.

There is a need for a method and system to overcome the above shortcomings of the prior art.

### SUMMARY OF THE INVENTION

Briefly, according to an embodiment of the present invention a method for creating an annotated transcript of a presentation includes steps or acts of: receiving an annotation stream recorded on a mobile device, wherein the annotation stream includes time stamped annotations corresponding to segments of the presentation; receiving a transcript of the presentation, wherein the transcript is time stamped; and merging the annotation stream with the transcript of the presentation by matching the time stamps from both the annotation stream and the transcript, for creating the annotated transcript of the presentation.

According to an embodiment of the present invention, a method for recording an annotation stream pertaining to a presentation on a mobile device includes steps or acts of: assigning a unique identifier to the annotation stream; creating the annotation stream, the annotation stream including annotations entered by a user of the mobile device, wherein each annotation is associated with at least one segment of the presentation; and then storing the annotation stream in the presentation. The method may include a step of receiving at least a portion of the presentation on the mobile device. The annotations may be selected from the following: text input, voice input, video, artwork, gestures, photographic input, and situational awareness sensor input. Additionally, the annotation stream may be transmitted to a device configured for merging the annotation stream with the transcript of the presentation in order to crate the annotated transcript.

According to an embodiment of the present invention, an information processing system for creating an annotated transcript of a presentation includes the following: an input/output subsystem configured for receiving a transcript of the presentation wherein the transcript is time stamped, and also configured for receiving an annotation stream, the annotations corresponding to segments of the presentation, wherein the annotation stream is time stamped; a processor configured for merging the annotation stream with the transcript of the presentation by matching the time stamps from both, for creating the annotated transcript. The system may also include an RFID reader for receiving a uniform resource locator of a location of the transcript of the presentation.

According to another embodiment of the present invention, a computer program product for creating an annotated transcript of a presentation includes instructions for enabling the product to carry out the method steps as previously described.

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1 is a high level block diagram showing an information processing system configured to operate according to an embodiment of the present invention;

FIG. 2 is a flow chart of a method for annotating a transcript with a mobile device, according to an embodiment of the present invention;

FIG. 3 is a simplified illustration of a mobile device receiving a media stream of a presentation, according to an embodiment of the present invention;

FIG. 4 is a simplified illustration of a mobile device with an affixed RFID tag, according to an embodiment of the present invention;

FIG. 5 is an illustration of one example of an annotated transcript according to an embodiment of the present invention;

FIG. 6 is an illustrative example of merging an annotation stream with a media stream, according to an embodiment of the present invention;

FIG. 7a is an illustration of an exploded comment bubble which can be advantageously used with an embodiment of the present invention;

FIG. 7b is an illustration of a minimized comment bubble which can be advantageously used with an embodiment of the present invention;

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

We describe a system and method that facilitates the collection and annotation of an audio/video presentation on a mobile device, independent of the presentation. With this method, a user is able to mark and annotate content related to a presentation on a mobile device and then merge the annotations with a portion of the presentation, creating an annotated transcript of the presentation. The user may be attending the live presentation or in the alternative, the user, at a later time, may receive a transcript of all or a portion of the presentation.

A presentation or transcript may take many forms. A presentation can be an actual live presentation with a speaker(s) and audience sharing a venue, or a webcast, or a recording such as a podcast or even an audio book on tape. A transcript is a processed representation of the presentation, generated in real-time or off-line, such as a character stream or text document, an edited video/sound recording, or a three dimensional (3D) animation capturing the aspects of the actual presentation considered relevant. For purposes of this discussion, we will use the terms “transcript” and “recording” to mean the same thing. We assume that the user is carrying a mobile device that is enabled for creating markings and annotations pertaining to the presentation. Enabled on the mobile device, or perhaps on a separate system, the user will need access to software for merging the annotations with the recorded presentation or its transcript.

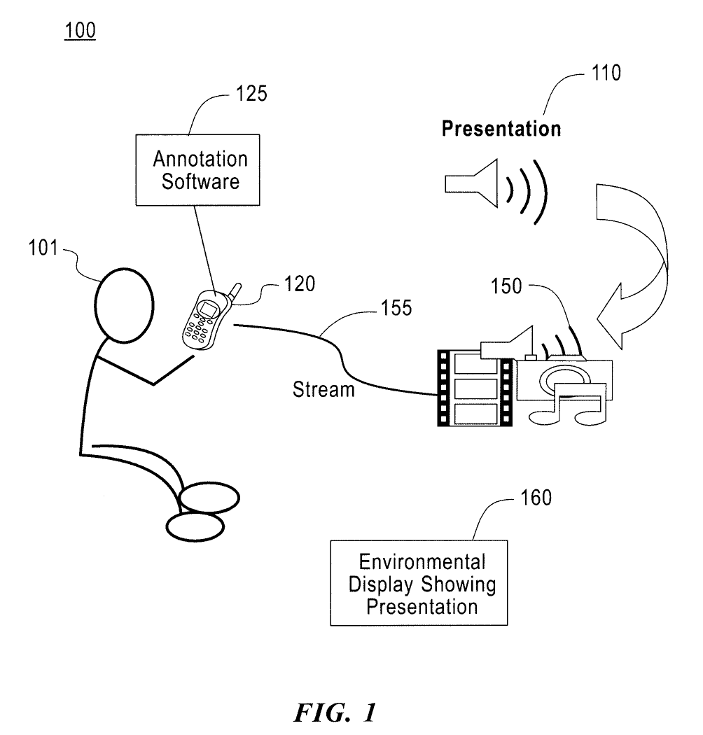

Referring now in specific detail to the drawings, and particularly FIG. 1, there is shown a simplified illustration of presentation scenarios 100 consistent with an embodiment of the present invention. The most likely scenario where an embodiment according to the invention is likely to be advantageously used is the case where a user (redactor) 101 is attending a live presentation 110 (either locally or broadcast) and the redactor 101 is carrying a mobile device 120 such as a laptop, cell phone or personal digital assistant. The redactor 101 uses the mobile device 120 such as a cell phone for making notations related to the presentation 110. It is important to note that the redactor 101 does not need the underlying content of the presentation 110 in order to make the annotations.

To create the annotations, the mobile device 120 is equipped with annotation software 125. There are various software tools available that can accept and display annotations. For example, Annotation SDK/ActiveX Plug-In from Black Ice provides easy to use tools for adding annotations, drawings, text, graphics, images, signature, stamps and sticky notes to a document. Notateit™ Annotation Software is another such tool.

Rather than a live presentation where the speaker and the redactor 101 are both in the same venue, the presentation 110 may be displayed on an environmental device 160 or other broadcast system. Another scenario is the case where the redactor 101 later receives or downloads a media stream 155 of all or a portion of the recorded, and possibly edited, presentation 110 and then makes annotations pertaining to the media stream 155. For either of these two scenarios, the redactor 101 merely has to activate an application 125 on his mobile device 120 for creating annotations and then either listen to the streamed presentation 150 or view it, or both. As the presentation 150 proceeds, the redactor 101 makes annotations on the mobile device 120. The streamed presentation 150 does not have to be playing on the mobile device 120 while the redactor 101 makes annotations. This underscores again one of the advantages of the present invention, namely that the redactor 101 does not need to acquire the underlying content before making the annotations. The annotations will correspond to certain portions of the presentation 150 and are being associated with those portions of the presentation 150 by timestamping them, A portion, or segment, of the presentation 150 may refer to an instance in time within the presentation 150 or it may encompass a range of time or the entire presentation 150.

Any mobile device with sufficient input capabilities will do, such as a laptop, cell phone, or personal digital assistant (PDA). A display screen and sound card are only required if the media stream 155 will play on the mobile device 120. The user may create these markings using a stylus, cursor, buttons, mouse, trackball, keyboard, cameras, voice input, or in some cases voice coupled with voice recognition software. Thus the annotations could be text, voice, artwork, graphical drawings, and or images.

If the presentation, live or recorded, or its transcript, is received as a digital media stream 155 played on the mobile device 120, the media player on the mobile device 120 will need to be integrated with the application 125 for creating the annotations. If the digital media stream 155 is played on a device other than the device for creating annotations, such as an environmental display 160, there must be an interaction between the application 125 for generating annotations and the computer system controlling the display 160. The integration of the two applications or the interaction is used to synchronize the annotation sequence to the digital media stream 155. This involves synching clocks. In this example, synchronizing refers to lining up the time stamps from both the media stream 155 and the annotation sequence.

If the presentation is a live local presentation 110, the annotation application 125 uses the local time on the mobile device 120 for the above synchronization. The local time of the mobile device 120 should be accurate in order for the annotations to be well synchronized with the recording 155. Subsequently, after the recording 155 of the presentation is made available, the redactor's 101 markings and annotations are merged with the recording 155 of the presentation 110 to create an annotated presentation. If the presentation 110 is broadcast from a different time zone, suitable adjustments will be made to account for the time difference between the time in the annotation zone and the time in the recording zone.

For purposes of this invention, mobile device 120 represents any type of information processing system or other programmable electronic device which can be carried easily, including a laptop computer, cell phone, a personal digital assistant, and so on. The mobile device 120 may be part of a network.

The mobile device 120 could include a number of operators and peripheral devices, including a processor, a memory, and an input/output (I/O) subsystem. The processor may be a general or special purpose microprocessor operating under control of computer program instructions executed from a memory. The processor may include a number of special purpose sub-processors, each sub-processor for executing particular portions of the computer program instructions. Each sub-processor may be a separate circuit able to operate substantially in parallel with the other sub-processors. Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips. The memory may be partitioned or otherwise mapped to reflect the boundaries of the various memory subcomponents.

The memory represents either a random-access memory or mass storage. It can be volatile or non-volatile. The mobile device 120 can also include a magnetic media mass storage device such as a hard disk drive.

The I/O subsystem may comprise various end user interfaces such as a display, a keyboard, a mouse, and a voice recognition speaker. The I/O subsystem may further comprise a connection to a network such as a local-area network (LAN) or wide-area network (WAN) such as the Internet. Processor and memory components may be physically interconnected using conventional bus architecture. Application software for creating annotations must also be part of the system.

What has been shown and discussed is a highly-simplified depiction of a programmable computer apparatus. Those skilled in the art will appreciate that a variety of alternatives are possible for the individual elements, and their arrangement, described above, while still falling within the scope of the invention. Thus, while it is important to note that the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of signal bearing media include ROMs, DVD-ROMs, and transmission-type media, such as digital and analog communication links, wired or wireless communications links using transmission forms, such as, for example, radio frequency and light wave transmissions. The signal bearing media make take the form of coded formats that are decoded for use in a particular data processing system.

Method Steps.

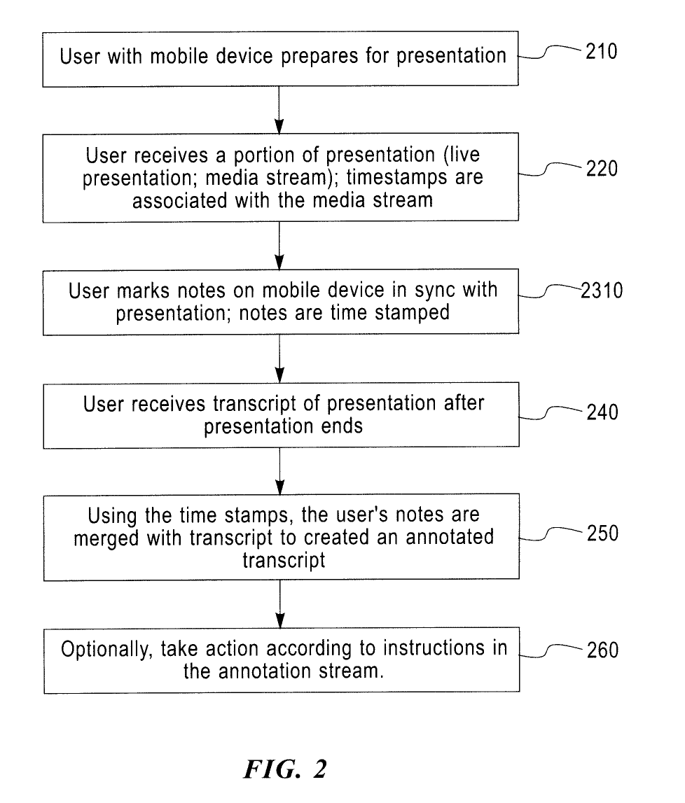

Referring to FIG. 2 there is shown a flow chart of a method for creating an annotated presentation with a mobile device 120, according to an embodiment of the present invention. The process begins at step 210 with a redactor 101 preparing for participating in the presentation 110. As stated earlier, the presentation may not necessarily be a live presentation 110 with a speaker where the redactor 101 is an audience member. Preparing for the presentation could take different forms, such as downloading the appropriate software, clearing the display screen, synchronizing time stamps, and so on. In the alternative, the redactor 101 may not participate in a presentation 110 at all. Instead, the redactor 101 may receive a transcript of the presentation 110.

Next, in step 220, the redactor 101 receives a portion of the presentation, either by listening to and viewing a live presentation 110, or downloading a media recording 155 of the presentation. According to one embodiment, in step 230, as the presentation progresses, the redactor 101 makes annotations on the mobile device 120, the annotations pertaining to portions of the presentation 110. These notes could be made directly on a display screen using a stylus, or by typing text into a file with word processing capabilities. Other formats for notes may include: voice input, graffiti, user's location data, camera input and identities of people near the user. Voice recognition software may be used to convert voice annotations to text. The capabilities for making annotations are limited only by the tools at the redactor's 101 disposal. In another embodiment, the redactor 101 first receives a transcript of the presentation 110 and then plays the recorded presentation and makes the annotations directly on the received transcript, or in concert with the received transcript.

In step 240, after the presentation 110 ends, at some point the redactor 101 receives a transcript of the presentation. Then in step 250, the notes the redactor made in concert with the presentation are merged with the transcript of the presentation, creating an annotated transcript. In this step the software on the mobile device 120 merges the annotation stream with the recorded presentation on the mobile device 120. In an alternate embodiment, the redactor 101 does not receive a transcript of the presentation 110 on the mobile device 120. In this alternate embodiment, the software transfers the annotation stream to a remote system where it is merged with the recorded presentation.

Optionally, in step 260, the user of the mobile device 120 may take action according to an instruction contained in the annotation stream. The action may be to forward to the annotated transcript to another user or to make further annotations.

Media Stream.

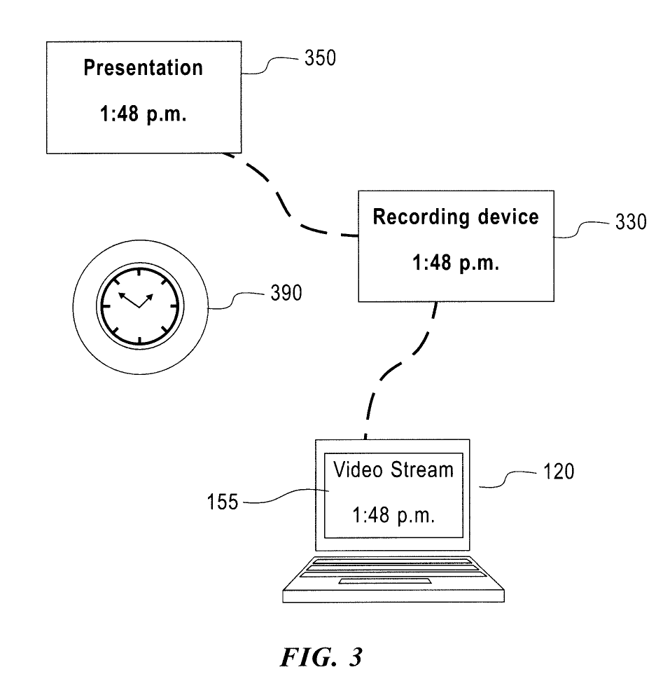

The media stream 155 could take many forms, from the simplest form of an audio recording to a webcast. Referring to FIG. 3 there is shown an illustration of the mobile device 120, represented as a laptop computer in FIG. 3, receiving a media stream 155 of a broadcasted presentation 350 from a recording device 330. The media stream 155 could be an audio/visual presentation recorded by a videocamera, or perhaps a webcast, or podcast.

Annotations.

As stated earlier, the annotations can be entered as text using a keyboard or stylus, or perhaps the annotation software 125 used in conjunction with the mobile device 120 includes a list of annotations that can be selected by touch or clicking. Some annotation tools provide an annotation selection menu listing various note formats. The list could be a user-generated customized list or a standard list of annotations provided by the software, or a combination of both. The interface to label the segment could include a selection of simple options such as “Did not follow,” “Needs investigation,” “Very Interesting,” “Don't believe it,” “Forward to person X,” and so on. These options may be presented as a drop-down menu, or as icons in an annotation menu toolbar. The “Forward to person X” option may be optimized to invoke the redactor's address book on the mobile device 120 and prompt the redactor 101 to select one or more names. To speed operation, a subset of the redactor's address book such as direct reports and N levels of upper management can be presented instead of the complete address book.

The redactor 101 may also annotate a segment or a time instance with text input, voice, or handwritten input on the mobile device 120. Other annotations could be added from input devices and sensors on the mobile device 120 that sense the environment, such as the user's locations, the other people in the room, events sensed by the device 120, and so forth. Such annotations will be denoted as an annotation stream. After the presentation, the mobile device 120 can be used to upload these annotations to the redactor's home personal computer or some other device.

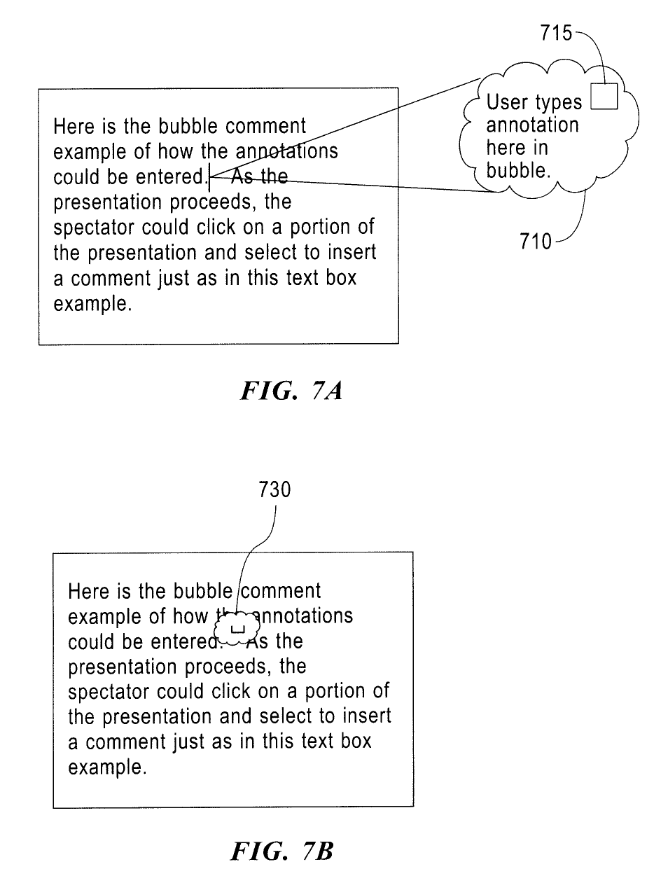

Text annotations can be displayed as a comment box or bubble, just as in the comment bubbles used in Adobe® Acrobat wherein the bubble appears as a small yellow text bubble next to the pertinent text. Referring to FIGS. 7a and 7B there is shown an example of the comment bubble example. In FIG. 7a the redactor 101 has selected a portion of the transcript to annotate by clicking on the display screen of the mobile device 120. An exploded comment bubble 710 will appear. Annotations can be typed into this box 710. Once the redactor 101 has finished typing in the annotation, the comment bubble 710 can be minimized by clicking on the minimize icon 715. The bubble will now appear as in FIG. 7b. Alternatively, the redactor 101 can enter a short note or comment on the device 120 and then enter a more lengthy description or comment into a file. The short note can be hyperlinked to the file. Voice annotations can be displayed on text transcripts as a special type of marker, possibly including the length of the recording. On a media transcript or recording, the display of voice or text annotations is highly dependent on the type of digital media used for the transcript or recording. For instance, if the popular MPEG-1 Audio Layer 3 (MP3) format is used, text annotations can be inserted as labels displayed at play time on the MP3 player screen. Voice annotations can be displayed as the name of the file containing the recording, possibly together with the author name, importance, date, time, and length of the recording.

In an alternative embodiment, voice annotations can be indicated as special sounds, such as a beep, and the media player may allow the user to switch to the annotation automatically for a limited period of time, say three seconds after the beep, or until the next annotation is encountered, i.e., the next beep is played.

Alternatively, sections of a text transcript can be marked in color—e.g., red for portions that the redactor 101 did not follow, yellow for portions that need follow-up, blue for portions that need to be forwarded. Many annotation tools include electronic highlighters for this purpose. The redactor 101 can then confirm the actions that need to be taken for each marked segment, such as forwarding them to other recipients. To mark an annotation in a voice recording or transcript, the sound level or pitch could be altered; similarly, annotations of video or animation segments or scenes can be implemented as temporary alterations of the color intensity and luminosity.

The redactor 101 can edit his time markings and adjust them if necessary. For example a rough estimate of “1 minute before this marker” can be made more precise. In one scenario, the redactor 101 may realize that a certain portion of the presentation 350 is important, but the presentation has progressed beyond the portion of interest. For instance a redactor 101 may want to annotate a particular audience question and the answer given by the speaker, but the redactor 101 realizes that the exchange is important only after hearing the question. Therefore, the redactor 101 must be able to specify that the annotation begins a specified number of seconds before the current time. This can be accomplished by providing the user with a means to go back in the recorded presentation or transcript by a specified time period, such as three seconds.

Synchronization.

While the markings and annotations are being made, the actual recording or transcript of the presentation 350 may not be available. In order to match up the markings and annotations with the transcript or recording which will be received at a later point in time, time stamps are used. The media stream 155, representing the live or recorded presentation will have time stamps associated with it. The presentation transcript, even when in text form, has relative time stamps, as well. The redactor 101 may override the relative time stamp and use a different start time, perhaps synchronized with a wall clock 390.

A situation can occur wherein the actual recording or transcript may be edited before the redactor 101 receives it, for instance to remove portions that are unimportant before the recording is published or to shorten the time duration of the presentation. For example, a “Q&A” (Question and Answer) portion following a speech may be deleted from the transcript. If the media stream 155 is edited, the segments prior to and following the edited portions are appropriately labeled with the time stamps. This is done by the presenter, the moderator of the event, the host of the meeting, the session chair, a professional editor-in-charge with editing presentations, etc. The time reference used by the recording device 330 and the redactor's mobile device 120 are synchronized so that a time stamp associated with an annotation created on the mobile device 120 matches the correct portion of the recording.

In the case where the redactor 101 annotates a portion of the presentation that is deleted before the redactor 101 receives the transcript, the annotations can either be dropped (silently or not) or included in the text and marked as referring to non-existing/deleted content. When the annotation is closely coupled to the presentation content, that annotation may need to be kept (perhaps a reminder to send that portion to another individual). In this case, the time stamp for the annotation will of course not match the time stamps of the transcript because that portion of the transcript was removed. Instead, another identifier should be used. The time stamps alone are not sufficient to identify the recorded media stream 155. For instance there may be many parallel sessions at a conference and all may have time stamps that span the same time range. One cannot simply assume that the time stamps are adequate to figure out to which stream 155 the annotation pertains. An annotation stream should always include some sort of ID for the presentation to which it refers, unless annotations are made directly to the media stream.

The recording device 330 and the mobile device 120 may synchronize their clocks to a well known global clock source. An error less than a second or 1/10 of a second is acceptable. Once synchronized, the mobile device 120 simply records the start and stop times and the redactor's annotations. As an alternative to actually modifying its internal clock, the mobile device 120 can simply calculate the time offset between its internal clock and the global clock source and use its internal clock adjusted with the appropriate offset to create the time markers. Once the clocks of the venue and the mobile device 120 are synchronized, the redactor 101 can use a simple interface on his mobile device 120 to mark sections of the talk.

The redactor 101 can first select an approximate duration for the current section, i.e., from this marked point to one minute before this marked point. Then the redactor 101 might assign an action or annotation to the marked segment.

In one embodiment of the present invention, when the redactor 101 participates in a presentation 350 which is being recorded, his mobile device 120 is provided with a URL indicating where the recording or transcript will be made available for download. The mobile device 120 associates this URL with the markings and annotations that are created by the redactor 101 to disambiguate between multiple parallel presentations. The URL, or presentation ID in the more general case, should be made part of the presentation, either spoken or displayed on the first slide/header or footer of all slides, etc. When the redactor 101 creates an annotation on the mobile device 120, we enable the redactor 101 to specify that the annotation refers to a live presentation that started some amount of time in the past to enable the redactor 101 to annotate portions after the presentation has started. A linear time scale may be presented graphically and the redactor 101 may select the last few seconds, or minutes or other periods. Other methods could include just clicking a button to indicate a period of time. Repeated activation of the button compounds the total time to the time desired by the redactor 101. The redactor 101 may just indicate this with text input or with a stylus.

Media Transfer.

There are many different ways in which the presentation 110 transcript can be transferred to the redactor 101. The redactor 101 may be able to download the transcript. One method, as discussed earlier, is to present to the mobile device 120 the URL where the transcript will be available. The URL may be broadcasted at the location where the presentation is being made. Alternatively, an RFID tag could be attached to each of the doors of the venue. If an RFID tag is used, the URL pointed to by the tag will contain the URL where the transcript will be available. If the mobile device 120 includes an RFID reader, it can read this transmission. The actual URL will keep changing for each talk. Each venue such as a conference room in a building could have a fixed URL whose contents change based on a calendar of events. In this model, the redactor 101 has to actively download the transcript from the URL.

Alternatively, the redactor 101 can scan his mobile device 120 at an RFID reader in the venue that can capture the redactor's email address encoded in an RFID tag 410 attached to the redactor's mobile device 120. The redactor 101 indicates by this act that a copy of the transcript should be automatically emailed to him. Also a reference/hyperlink to the transcript generated in real-time (perhaps using closed-captioning techniques) or live presentation stream is sent to the mobile device 120 immediately so that the annotations created on the mobile device 120 can be made directly on the continuously downloaded transcript or on a recording of the live presentation stored locally. The venue provides a method to synchronize the clock used by the venue with the clock on the user's mobile device 120 so that the redactor's time markings can be positioned correctly in the transcript stream 310. The clock time at the venue can be communicated with a short range wireless broadcast beacon.

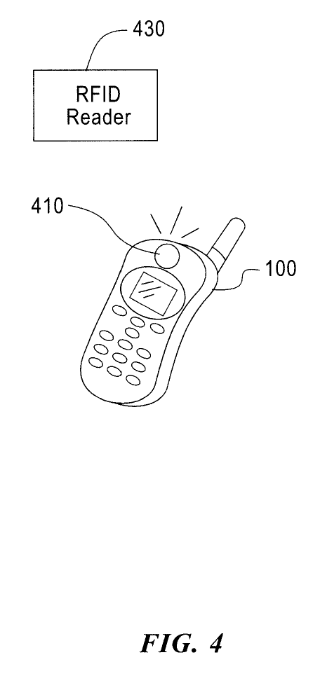

Referring to FIG. 4 there is shown an illustration of the mobile device 120 with an attached RFID tag 410 in range of an RFID reader 430. Here the positions of the tag and the reader are reversed from the previous example. Note that the mobile device 120 here is shown in the cellular phone form factor. The RFID tag 410 may be easily affixed to the mobile device 120 using tape. RFID tags are well-known; therefore an explanation of how the tags operate is not necessary. New technology called NFC (Near Field Communication) allows mobile devices such as cell phones to include tag readers that can read tags within a short range. In this scenario, the redactor 101 will just wave his cell phone over the tag just like one may wave a badge in front of a reader, but in this case the positions of the tag and reader are reversed.

Merging.

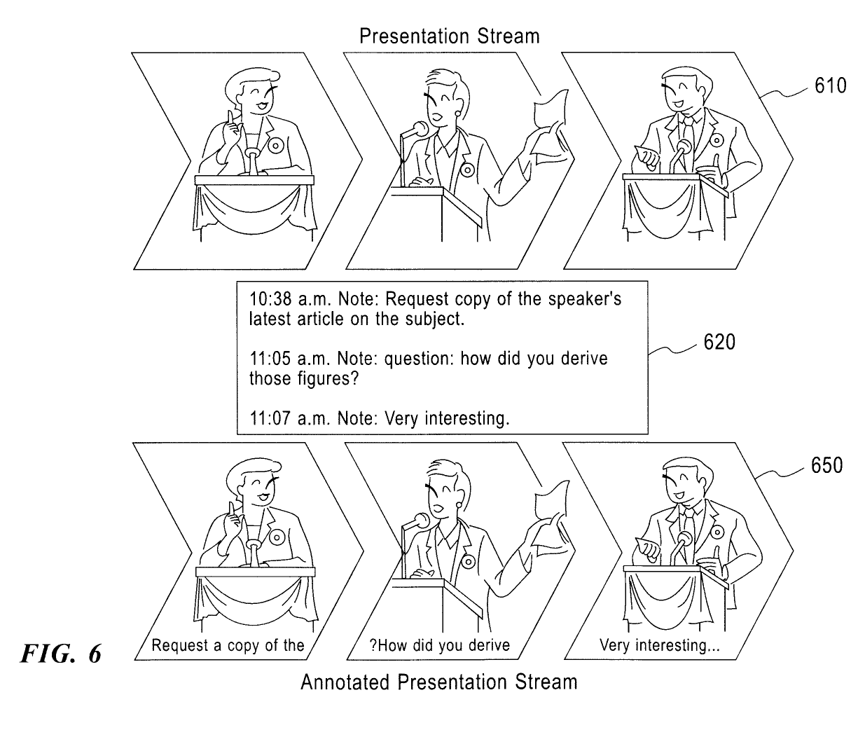

Referring to FIG. 6 there is shown a simplified illustration of the merging of a portion of a presentation 610 with annotations 620, creating an annotated presentation 650.

According to an embodiment of the present invention, an application for merging an annotation stream with a presentation transcript must be able to handle both formats, the annotation format and whatever media format the transcript is in. An application tool used to create the annotations may be modified according to the methods stated herein to merge the two mediums based on their time stamps.

At a later point in time, when the recorded stream is edited and made available, the edited stream, which has so far been referred to as the recorded presentation or its transcript, can be downloaded to a personal computer (PC) and the annotation sequence 620 is merged with the stream 155 to create an annotated stream 650. The merging of the two streams is dependent on the formats used for the two streams, but it will typically involve mixing text, sound and video frames from the two streams in their time stamp order.

Now, the mobile device or the PC can then process the annotations. For example, if the annotations indicate segments to be emailed to selected recipients, the merging program invokes the local email client with the appropriate commands. If necessary, the redactor 101 can manually adjust the synchronization of the markings with the transcript viewer. An audio annotation will also be converted to text using voice to text software so the redactor 101 can quickly look at the annotated transcript instead of the slow serial process that is needed with listening to audio.

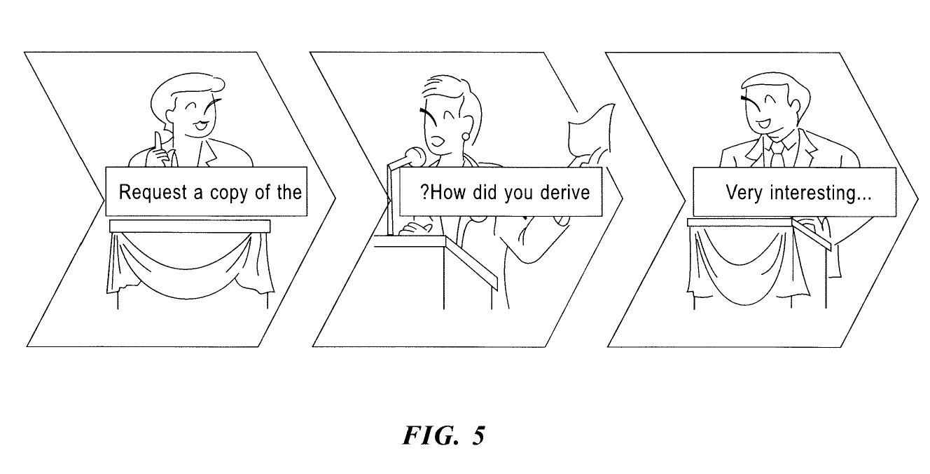

There are different ways to merge the two streams. In one embodiment, the annotation stream 620 is overlaid on top of the recorded transcript 610. With this embodiment there are a few different ways the annotations can be displayed together with the presentation. One way is for the annotations to appear as “subtitles” as shown in FIG. 6, or the annotations can appear directly over the presentation as shown in FIG. 5. As discussed earlier, comment bubbles can be used. Clicking on the minimized bubble 730 causes it to pop-up so that the text is readable. Methods for visualizing annotations to video streams were discussed earlier.

Therefore, while there has been described what are presently considered to be the preferred embodiments, it will be understood by those skilled in the art that other modifications can be made within the spirit of the invention. The above descriptions of embodiments are not intended to be exhaustive or limiting in scope. The embodiments, as described, were chosen in order to explain the principles of the invention, show its practical application, and enable those with ordinary skill in the art to understand how to make and use the invention. It should be understood that the invention is not limited to the embodiments described above, but rather should be interpreted within the full meaning and scope of the appended claims.

We claim:

1. A method for creating an annotated transcript of a presentation, the method comprising steps of:
receiving an annotation stream recorded on a mobile device, wherein the annotation stream comprises time stamped annotations corresponding to segments of the presentation;
receiving a transcript of the presentation, wherein the transcript is time stamped; and
merging the annotation stream with the transcript of the presentation by matching the time stamps from both the annotation stream and the transcript, for creating the annotated transcript of the presentation.

2. The method of claim 1, wherein the presentation is at least one item selected from a group consisting of: live presentation, broadcast presentation, podcast, webcast, videoconference, class lecture, audio book, and visual software presentation.

3. The method of claim 1, wherein the merging step comprises:
overlaying the annotation stream over the transcript such that the annotations are displayed in close proximity to the segments of the presentation to which they correspond.

4. The method of claim 1, wherein the merging step comprises:
hyper-linking the annotations to the corresponding segments of the transcript.

5. The method of claim 1 wherein the step of receiving the transcript of the presentation comprises receiving a digital media stream.

6. The method of claim 5 wherein receiving the digital media stream comprises receiving a uniform resource locator indicating the location of an electronic format of the transcript for downloading.

7. The method of claim 6 wherein receiving the uniform resource locator comprises receiving an electronic mail transmission with the uniform resource locator.

8. The method of claim 7 wherein receiving the electronic mail transmission occurs automatically upon a user providing an electronic mail address.

9. The method of claim 8 wherein providing the electronic mail address comprises transmitting the electronic mail address to a reader through an RFID tag comprising the electronic mail address of a user of the mobile device affixed to the mobile device.

10. The method of claim 1, further comprising a step of displaying the annotated transcript.

11. The method of claim 1, further comprising a step of executing commands included in the annotation stream.

12. A method for recording an annotation stream pertaining to a presentation on a mobile device, the method comprising steps of:
assigning a unique identifier to the annotation stream;
creating the annotation stream, the annotation stream comprising annotations entered by a user of the mobile device, wherein each annotation is associated with at least one segment of the presentation; and
storing the annotation stream.

13. The method of claim 12 further comprising a step of:
receiving at least a portion of the presentation on the mobile device.

14. The method of claim 12 wherein the annotations are selected from a group consisting of: text input, voice input, video, artwork, gestures, photographic input, and situational awareness sensor input.

15. The method of claim 12 wherein the creating step further comprises a step of:
specifying that at least one of the annotations pertains to a segment of the presentation that begins a specified time interval before a current time.

16. The method of claim 12 further comprising a step of:
receiving the transcript of the presentation on the mobile device.

17. The method of claim 12 further comprising a step of:
transmitting the annotation stream to a device configured for merging the annotation stream with the transcript of the presentation for creating an annotated transcript.

18. An information processing system for creating an annotated transcript of a presentation, the system comprising:
an input/output subsystem configured for receiving a transcript of the presentation wherein the transcript is time stamped, and also configured for receiving an annotation stream comprising annotations, the annotations corresponding to segments of the presentation, wherein the annotation stream is time stamped;
a processor configured for performing a step of:
merging the annotation stream with the transcript of the presentation by matching the time stamps from both, for creating the annotated transcript.

19. The system of claim 11 further comprising an RFID tag reader for receiving a uniform resource locator comprising a location of the transcript of the presentation.

20. A computer program product for creating an annotated transcript of a presentation, the computer program product comprising instructions enabling the product to:
receive a time stamped transcript of the presentation, and also configured for receiving an annotation stream comprising annotations, the annotations corresponding to segments of the presentation, wherein the annotation stream is time stamped; and
merge the annotation stream with the transcript of the presentation by matching the time stamps from both, for creating the annotated transcript.
